(19) United States
(12) Patent Application Publication
(10) Pub. No.: US 2010/0245323 A1
(43) Pub. Date: Sep. 30, 2010

(54) Power Management Integrated Circuit, Power Management Method, and Display Apparatus

(76) Inventor: Ju-Lin Chia, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 12/723,679

(22) Filed: Mar. 14, 2010

(30) Foreign Application Priority Data
Mar. 27, 2009 (TW) 098110231

(51) Int. Cl. G06F 3/038; G05F 1/10

(52) U.S. Cl. 345/211; 327/544

(57) ABSTRACT

Power management integrated circuit and related devices. A clock generator generates a periodic signal. Based on the periodic signal and a feedback signal, a pulse width modulator generates a control signal, based on which a driver drives a power switch. A power terminal is connected to an external capacitor. A linear regulator connected to the power terminal generates and supplies an internal power source. Powered by the internal power source, a bandgap generator provides a bandgap reference voltage. A standby control terminal receives a standby signal. When the standby signal is asserted, the clock generator, the pulse with modulator and the driver are at a disabled state, and the linear regulator and the bandgap generator at an enabled state.

### BACKGROUND OF THE INVENTION

1. Field of the Invention

The present invention is related to a power management device for electronic devices and the control method thereof.

2. Description of the Prior Art

FIG. 1 is a diagram illustrating a conventional display device. Alternating Current (AC) input 106 is coupled to a commercial power source such as the AC source of 110 volt (V) or 220V. Power source board 104 converts the commercial power source to a voltage power source with appropriate voltage level, to be provided to interface board 110 and backlight driver 102. Backlight driver 102 is utilized to drive the backlight module of Liquid Crystal Display (LCD) panel 108. Interface board 110 comprises a microprocessor unit (MCU) and a video scaler. The video scaler acts as an image controller for controlling the image displayed on LCD panel 108 according to the signals from the VGA or DVI connector. Interface board 110 is also coupled to keyboard 112 of the display device, in which the keys such as the power switch key and the image adjustment key are disposed upon.

To satisfy the power saving requirement, the conventional display device usually focuses on the power saving effect of each individual function unit; for example, focusing on reducing the power consumption of the LCD panel or the interface board, or focusing on improving the efficiency of the power source board specifically. However, limitations exist for each individual function unit as to how much power can be saved, so design difficulties is likely to arise when facing strict power saving requirement.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional display device.

FIG. 2 is a diagram illustrating the display device of the present invention.

FIG. 3 is a diagram illustrating an embodiment of power source board of the present invention.

FIG. 4 is a diagram illustrating an embodiment of power management IC.

FIG. 5A is a diagram illustrating an embodiment of standby controller in FIG. 4.

FIG. 5B is a diagram illustrating another embodiment of standby controller in FIG. 4.

### DETAILED DESCRIPTION

Further objects of the present invention and more practical merits obtained by the present invention will become more apparent from the description of the embodiments which will be given below with reference to the accompanying drawings. For explanation purposes, components with equivalent or similar functionalities are represented by the same symbols. Hence components of different embodiments with the same symbol are not necessarily identical. Here, it is to be noted that the present invention is not limited thereto.

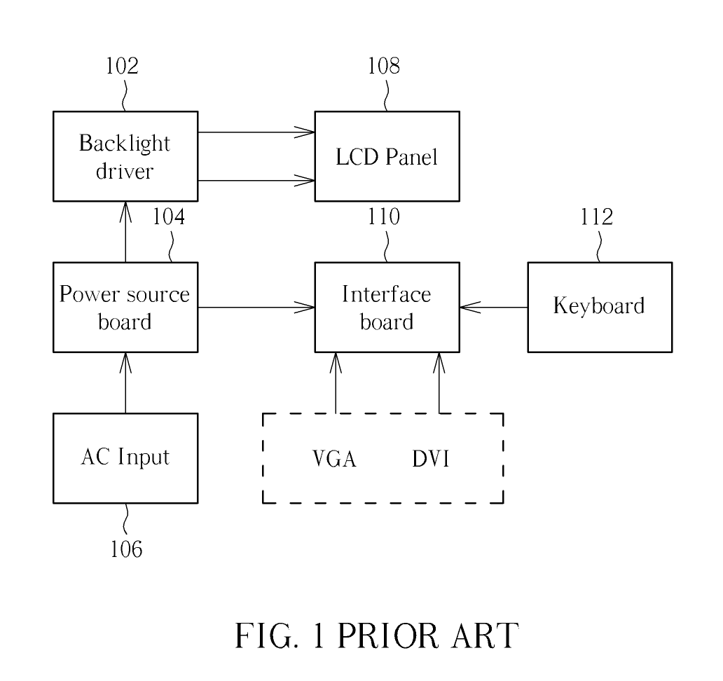

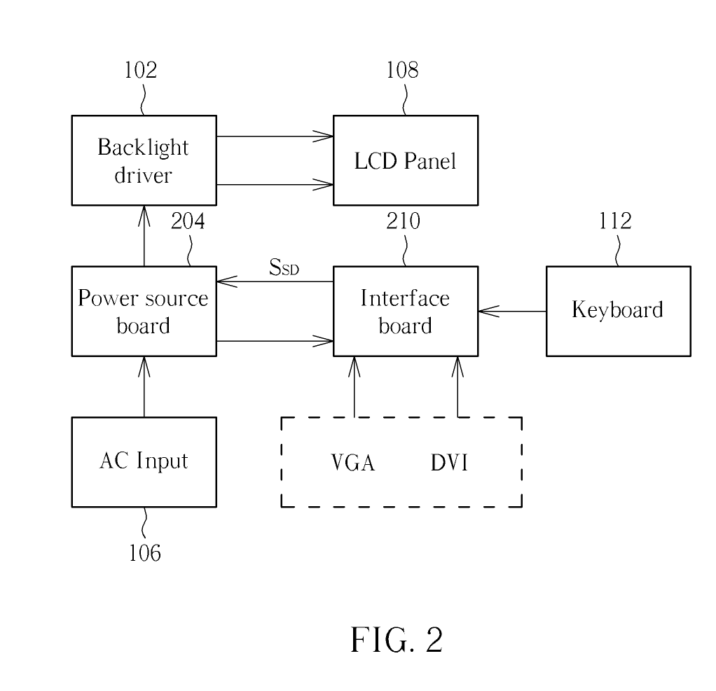

FIG. 2 is a diagram illustrating the display device according to the embodiment of the present invention. The display device comprises AC input 106, power source board 204, backlight driver 102, Liquid Crystal Display (LCD) panel 108, interface board 210 and keyboard 112. The descriptions of the components similar or identical to those of FIG. 1 are omitted hereinafter. Interface board 210 comprises a microprocessor unit (MCU) and a video scaler. The video scaler acts as an image controller for controlling the image displayed on LCD panel 108 according to the signals from the VGA or DVI connector. In one embodiment of the present invention, when determining that the display device of FIG. 2 should enter into the standby mode, in addition to turning off LCD panel 108 and backlight driver 102, the video scaler enables standby signal S_{SD}, as illustrated in FIG. 2, to make power source board 204 enter into the standby mode consuming minimal power.

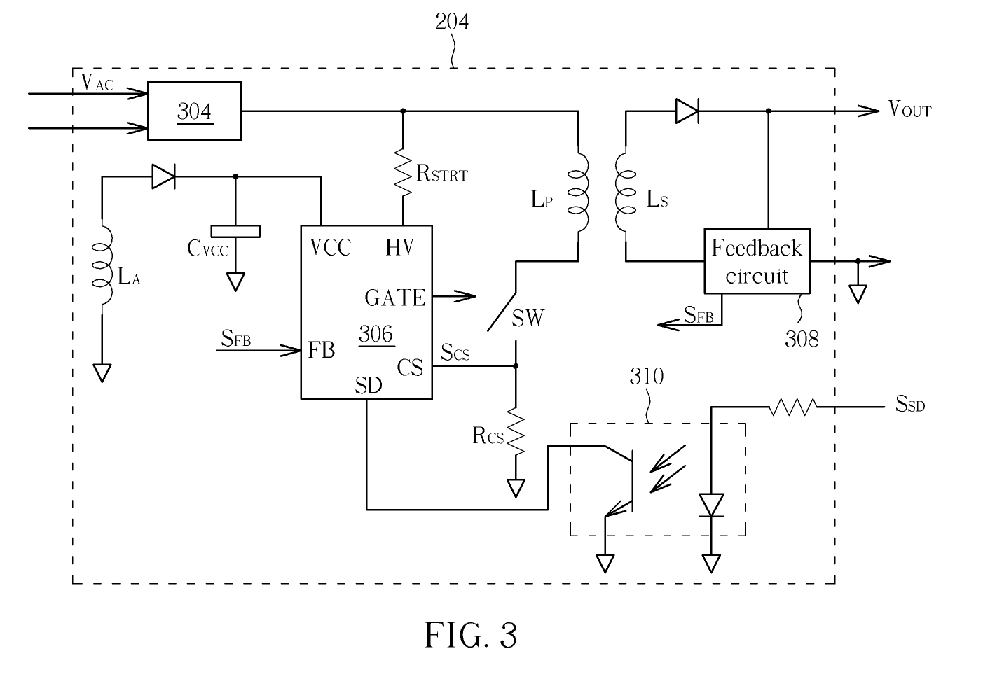

FIG. 3 is a diagram illustrating an embodiment of power source board 204 of the present invention. In FIG. 3, power source board 204 comprises a flyback converter for converting the electrical energy received from AC power source V_{AC} to output voltage source V_{OUT} of desired specification. Bridge rectifier 304 roughly rectifies AC power source V_{AC}. Power switch SW coupled to gate terminal GATE of power management integrated circuit (IC) 306 is used for controlling the current of primary coil L_{P} of the transformer. When power switch SW is turned on, the electrical energy stored in the transformer increases; when power switch SW is turned off, the electrical energy stored in the transformer is discharged via secondary coil L_{S} and auxiliary coil L_{A}. The electrical energy discharged by secondary coil L_{S} is transmitted via the rectifier and then stored in an output capacitor so as to provide the output voltage source V_{OUT} for backlight driver 102 or interface board 210. The electrical energy output by auxiliary coil L_{A} is transmitted to power source terminal VCC of power management IC 306 to provide the operational voltage VCC required by power management IC 306.

Feedback circuit 308 monitors the amplitude (such as current, voltage, or power) of output voltage source V_{OUT} so as to provide feedback signal S_{FB} to feedback terminal FB of power management IC 306. High voltage terminal HV of power management IC 306 is coupled to a rectified power line via startup resistor R_{STRT}. Current detecting terminal CS of power management IC 306 is utilized to detect the current flowing through power switch SW by detecting voltage V_{CS} across detection resistor R_{CS}. Light coupler 310 is coupled to standby control terminal SD. Through light coupler 310, standby control terminal SD equivalently receives standby signal S_{SD}. When standby signal S_{SD} is asserted (i.e. enabled), power management IC 306 enters an OFF mode (i.e. power management IC 306 is off/disabled).

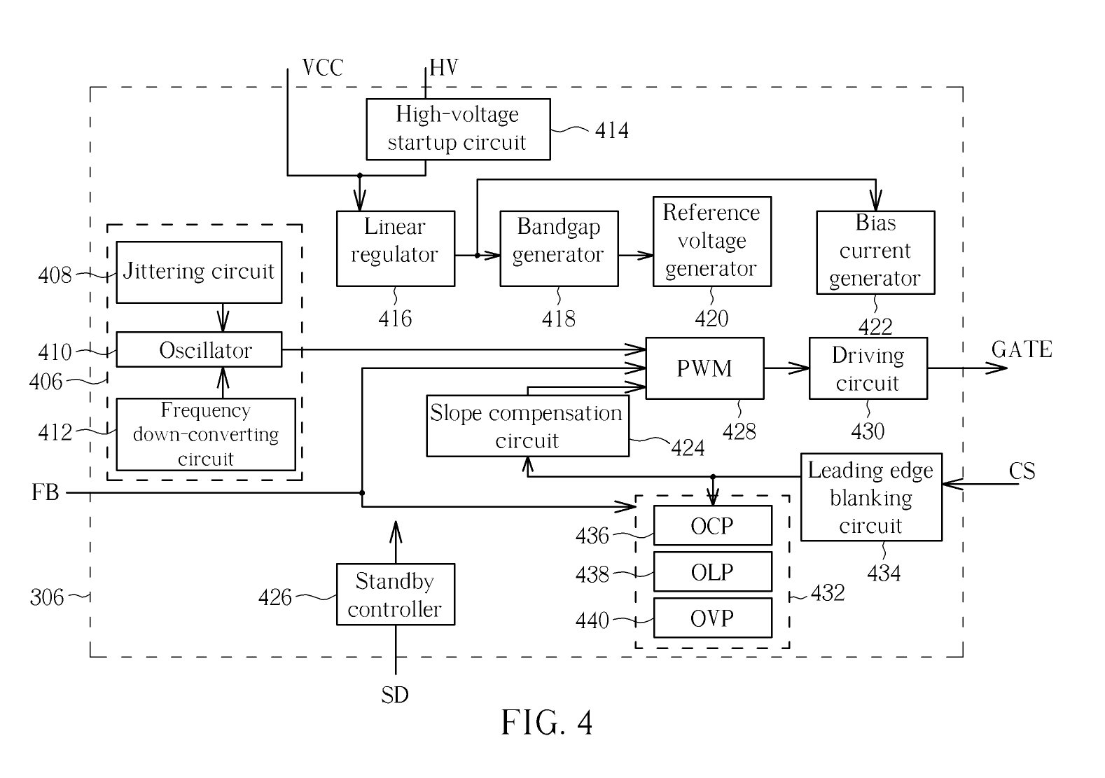

FIG. 4 is a diagram illustrating an embodiment of power management IC 306. As illustrated in FIG. 3, high-voltage startup circuit 414 receives a rectified voltage signal of high voltage level from high voltage terminal HV. Within a startup duration, before operational voltage VCC reaches a predetermined voltage level (for instances, 20V), high-voltage startup circuit 414 supplies a current to charge filter capacitor C_{VCC} via power source terminal VCC. Linear regulator 416 coupled to power source terminal VCC is used to generate an internal power source of a lower voltage level, such as 5V, which is supplied to the internal circuitries requiring lower operational voltage. Bandgap generator 418 powered by linear regulator 416 is used to generate a bandgap reference voltage, based on which reference voltage generator 420 generates other reference voltages required by other internal circuitries. Bias current generator 422 powered by linear regulator 416 is used to generate constant current sources required by the internal circuitries.

Clock generator 406 utilizes oscillator 410 to generate periodic signals such as the saw-tooth waveform signal or other equivalent clock signals. To reduce the Electromagnetic Interference (EMI), oscillator 410 is controlled by jittering circuit 408, so the frequency of the periodic signal periodically varies within a predetermined frequency range. For instance, jittering circuit 408 makes the frequency of the periodic signal of clock generator 406 gradually vary back-and-forth between 60 kHz and 70 kHz. Frequency down-converting circuit 412 alters the frequency of the periodic signal according to feedback signal S_{FB}. More particularly, when feedback signal S_{FB} indicates power source board 204 operating under light load or no load, frequency down-converting circuit 412 lowers the frequency of the periodic signal to lower switching loss, For instances, 65 kHz is the frequency of the periodic signal under normal load and 20 kHz that under light load or no load.

Pulse width modulator (PWM) 428 controls driving circuit 430 according to feedback signal S_{FB} from feedback terminal FB, feedback signal S_{CS} from current detecting terminal CS, and the periodic signal from clock generator 406. Driving circuit 430 controls power switch SW in FIG. 2 via gate terminal GATE. During an initial period after power switch SW is turned on, leading edge blanking circuit 434 blocks feedback signal S_{CS} from being transmitted to pulse width modulator 428 so that the noise caused by the parasitic capacitor of power switch SW cannot erroneously affect pulse width modulator 428 via feedback signal S_{CS}. Slope compensation circuit 424 coupled between leading edge blanking circuit 434 and pulse width modulator 428 is used to prevent the occurrence of sub-harmonic oscillation known by those skilled in the art.

Power management IC 306 comprises certain protection circuits 432; for instances, Over Current Protection (OCP) circuit 436 limits the current flowing through power switch SW by monitoring feedback signal S_{CS}; Over Load Protection (OLP) circuit 438 prevents excessively high power output resulted from excessively low voltage level of output voltage source V_{OUT} by monitoring feedback signal S_{FB}; Over Voltage Protection (OVP) circuit 440 prevents power management IC 306 from being damaged resulted from operational voltage VCC of excessively high voltage level by monitoring operational voltage VCC.

Standby controller 426 is coupled to standby control terminal SD, for determining whether standby signal S_{SD} is asserted. In one embodiment of the present invention, when standby controller 426 determines standby signal S_{SD} asserted, standby controller 426 ensures linear regulator 416, bandgap generator 418 and standby controller 426 itself are under normal operation (i.e. in the enabled state) but turns off/disables other circuitries (i.e. to enter the disabled state) so as to lower the power consumption during standby.

It is worth mentioning that the said enabled state indicates that the required signals and operations in the normal operation are present; disabled state indicates that approximately no current flow is present in the analog part of the circuit and no variations is occurred of the digital output signal of the digital part of the circuit. For instances, if standby controller 426 controls clock generator 406 to be in the disabled state, linear regulator 416 or operational voltage VCC still supplies power to clock generator 406, but the current sources within clock generator 406 are all turned off and the logic levels of all the digital signals in clock generator 406 remains unchanged. Therefore, when standby controller 426 controls clock generator 406 to recover back to the enabled state, the current source within clock generator 406 is resumed to provide current and the digital signals may toggle according to corresponding inputs.

In other words, in an embodiment of the present invention, when standby controller 426 determines standby signal S_{SD} is asserted, linear regulator 416 continues to supply the internal circuitries with an internal power source of a lower voltage level; bandgap generator 418 continues to generate bandgap reference voltage; standby controller 426 continues to determine whether the standby signal S_{SD} is kept as asserted; and the other internal circuitries of power management IC 306, while supplied with power, can be deemed as consuming no power. Therefore, when standby controller 306 determines standby signal S_{SD} is asserted, power management IC 306 enters the OFF mode, in which minimal power is consumed.

When standby controller 426 determines standby signal S_{SD} changes from the enabled state to the disabled state, power management IC 306 exits the OFF mode and standby controller 426 converts the internal circuitries from the disabled state to the enabled state.

When standby signal S_{SD} is asserted, the corresponding circuitries entering the disabled state can be designated according to the user requirement. For instances, in another embodiment of the present invention, when standby signal S_{SD} is asserted, only standby controller 426 and linear regulator 416 are in the enabled state, and the other circuitries of power management IC 306 are in the disabled state. In yet another embodiment of the present invention, when standby signal S_{SD} is asserted, only standby controller 426, linear regulator 416, reference voltage generator 420, and bias current generator 422 are in the enabled state, and the other circuitries of power management IC 306 are in the disabled state. This way, the time required for power management IC 306 exiting the OFF mode may be effectively reduced.

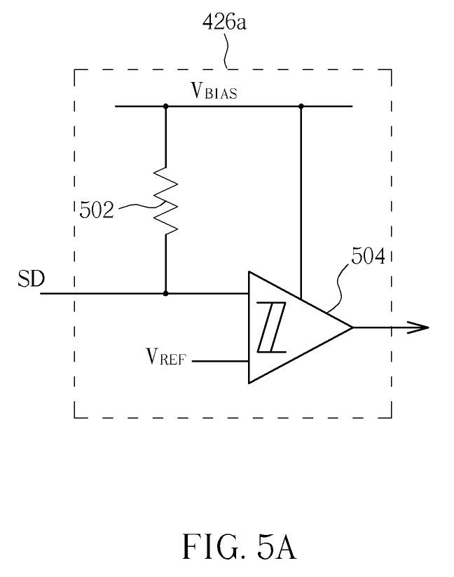

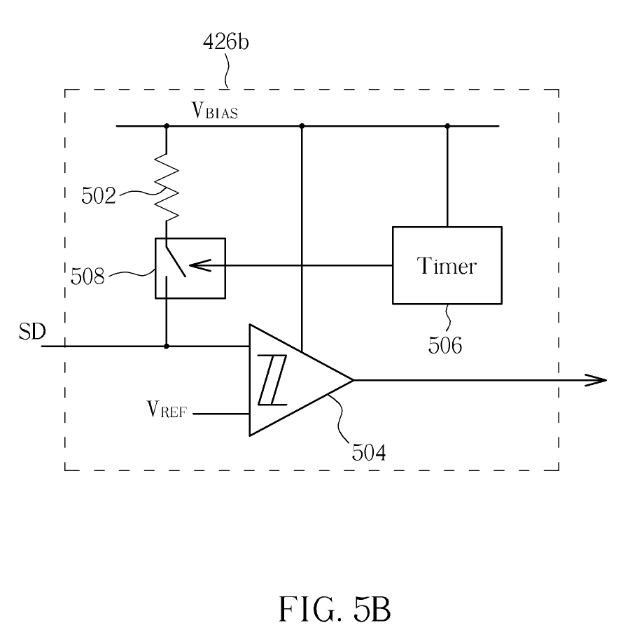

FIG. 5A is a diagram illustrating an embodiment of standby controller 426 in FIG. 4. The power source V_{BIAS} of standby controller 426a may be supplied from linear regulator 416. Resistor 502 coupled between power source V_{BIAS} and standby control terminal SD acts as a current provider to supply a detection current. Comparator 504 compares the voltage levels of standby control terminal SD and reference voltage V_{REF}. Suppose standby signal S_{SD} is asserted/not asserted if it is at a relatively high/low voltage level respectively. When standby signal S_{SD} is asserted, light coupler 310 pulls down the voltage level of standby control terminal SD, and when comparator 504 detects the voltage level of standby control terminal SD is lower than that of reference voltage V_{REF}, standby signal S_{SD} is determined to be asserted and then certain circuitries of power management IC 306 are accordingly disabled. On the other hand, when comparator 504 detects the voltage level of standby control terminal SD is higher than that of reference voltage V_{REF}, standby signal S_{SD} is then determined as not asserted so the previously disabled circuitries of power management IC 306 are then charged to become enabled.

FIG. 5B is a diagram illustrating another embodiment of standby controller 426 in FIG. 4. Compare to FIG. 5A, standby controller 426b of FIG. 5B comprises additional timer 506 and switch 508. When power management IC 306 enters the OFF mode, timer 506 starts to turn on and turn off switch 508 periodically such that the detection current flowing through resistor 502 flows into standby control terminal SD discontinuously. When standby signal S_{SD} is asserted, the voltage level of standby control terminal SD is maintained to be lower than that of reference voltage V_{REF}, regardless whether switch 508 is turned on or off. When standby signal S_{SD} is not asserted, the voltage level of standby control terminal SD is higher than that of reference voltage V_{REF} only when switch 508 is turned on; comparator 504 can then determine that standby signal S_{SD} is not asserted, making power management IC 306 exit the OFF mode, and timer 506 can be terminated accordingly so that switch 508 keeps turned on continuously. Therefore, in the OFF mode, the detection current flowing through resistor 502 is only present periodically, so the power consumption of standby controller 426 is even further reduced.

In yet another embodiment of the present invention, when power management IC 306 enters the OFF mode, the power consumed by power management IC 306 is supplied solely by filter capacitor C_{VCC}; the power consumed by interface board 210 in FIG. 2 is supplied solely by the output capacitor (not shown) coupled to output voltage source V_{OUT}. In the OFF mode, interface board 210 detects the voltage level of output voltage source V_{OUT} to determine whether to disable standby signal S_{SD}. For instances, assuming the target voltage level of output voltage source V_{OUT} is 5V, and the lowest voltage level of output voltage source V_{OUT} that interface board 210 can tolerate is 3.8V; when in the OFF mode, interface board 210 disables standby signal S_{SD} as soon as the voltage level of output voltage source V_{OUT} decreases down to 3.8V, so power management IC 306 can exit the OFF mode and the voltage level of output voltage source V_{OUT} rises back to 5V. In another embodiment, interface board 210 in FIG. 2 enables and disables standby signal S_{SD} periodically. For instances, after interface board 210 enables standby signal S_{SD} for one second, standby signal S_{SD} is then not asserted (i.e. disabled), so output voltage source V_{OUT} is recovered back to 5V so as to prevent operational voltage VCC from reaching an exceedingly low voltage level.

In yet another embodiment of the present invention, when the power management IC enters the OFF mode, all the internal circuitries, apart from the linear regulator, the bandgap generator and the standby controller, are disabled. This way, the power consumption of the power management IC during standby can then be kept to a minimal extent.

Those skilled in the art will readily observe that numerous modifications and alterations of the device and method may be made while retaining the teachings of the invention.

What is claimed is:

1. A power management integrated circuit (IC), comprising:
a clock generator, for generating a periodic signal;
a pulse width modulator, for generating a control signal according to the periodic signal and a feedback signal.
a driving circuit, for driving a power switch according to the control signal;
a power source terminal, coupled to a filter capacitor;
a linear regulator, coupled to the power source terminal, for generating and supplying a internal power source;
a bandgap generator, powered by the internal power source, for providing a bandgap reference voltage; and
a standby control terminal, for receiving a standby signal;
wherein when the standby signal is asserted, the clock generator, the pulse width modulator, and the driving circuit are all in a disabled state, and the linear regulator as well as the bandgap generator are in an enabled state.

2. The power management IC of claim 1, further comprising:
a reference voltage generator, for generating at least one corresponding reference voltage, according to the bandgap generator;
wherein when the standby signal is asserted, the reference voltage generator is in the disabled state.

3. The power management IC of claim 1, further comprising:
a high-voltage startup circuit, receiving a high voltage source from a high voltage terminal, for supplying a charge current to charge the filter capacitor in an startup duration;
wherein when the standby signal is asserted, the high-voltage startup circuit stops supplying the charge current.

4. The power management IC of claim 1, further comprising:
a protection circuit, for disabling the control signal according to the feedback signal;
wherein when the standby signal is asserted, the protection circuit is in the disabled state.

5. The power management IC of claim 1, wherein the feedback signal corresponds to a current flowing through the power switch, and the power management IC further comprises:
a leading edge blanking circuit, for blocking the feedback signal being transmitted to the pulse width modulator during an period after the power switch is turned on;
wherein when the standby signal is asserted, the leading edge blanking circuit is in the disabled state.

6. The power management IC of claim 1, further comprising:
a standby controller, coupled to the standby control terminal, comprising:
a current provider, for generating a detection current;
a timer, periodically enables the detection current to flow into the standby control terminal; and
a comparator, for determining whether the standby signal is asserted, according to a voltage level of the standby control terminal.

7. The power management IC of claim 1, further comprising:
a standby controller, coupled to the standby control terminal, for determining whether the standby signal is asserted;
wherein when the standby signal is asserted, only the standby controller, the linear regulator, and the bandgap generator are in the enabled state.

8. The power management IC of claim 1, wherein the clock generator comprises:
an oscillator, for generating the periodic signal;
a jitter control circuit, for controlling the oscillator so a frequency variation of the periodic signal can be controlled within a predetermined frequency range; and
a frequency down-converting circuit, for controlling the oscillator to alter the frequency of the periodic signal according to the feedback signal.

9. A power management method, comprising:
providing a power management IC, comprising:
a clock generator, for generating a periodic signal;
a pulse width modulator, for generating a control signal, according to the periodic signal and a feedback signal;
a driving circuit, for driving a power switch, according to the control signal;
a power source terminal, coupled to a filter capacitor;
a linear regulator, coupled to the power source terminal, for generating and supplying an internal power source; and
a bandgap generator, powered by the internal power source, for providing a bandgap reference voltage;
receiving a standby signal;
determining whether the standby signal is asserted; and
disabling the clock generator, the pulse width modulator and the driving circuit and enabling the linear regulator and the bandgap generator when the standby signal is asserted.

10. The power management method of claim 9, wherein the power management IC further comprises:
a reference voltage generator, for generating at least one corresponding reference voltage, according to the bandgap generator;
wherein when the standby signal is asserted, the reference voltage generator is disabled.

11. The power management method of claim 9, wherein the power management IC further comprises:
a high-voltage startup circuit, receiving a high voltage source from a high voltage terminal, for supplying a charge current to charge the filter capacitor in an startup duration;
wherein when the standby signal is asserted, the high-voltage startup circuit stops supplying the charge current.

12. The power management method of claim 9, further comprising:
when the standby signal is asserted, periodically providing a detection current to the standby control terminal.

13. The power management method of claim 9, wherein the power management IC further comprises:
a standby controller, coupled to the standby control terminal, for determining whether the standby signal is asserted;
wherein when the standby signal is asserted, only the standby controller, the linear regulator, and the bandgap generator are enabled.

14. A display device, comprising:
a display panel;
an image controller, for controlling images displayed on the display panel, as well as supplying a standby signal; and
a power management IC, comprising:
a clock generator, for generating a periodic signal;
a pulse width modulator, for generating a control signal, according to the periodic signal and a feedback signal;
a driving circuit, for driving a power switch according to the control signal, to supply power to the image controller;
a power source terminal, coupled to a filter capacitor;
a linear regulator, coupled to the power source terminal, for generating and supplying an internal power source;
a bandgap generator, powered by the internal power source, for providing a bandgap reference voltage; and
a standby control terminal, coupled to the image controller, for receiving the standby signal;
wherein when the standby signal is asserted, the clock generator, the pulse width modulator and the driving circuit are all in a disabled state, the linear regulator and the bandgap generator are in an enabled state.

15. The display device of claim 14, wherein the power management IC further comprises:
a standby controller, coupled to the standby control terminal, for determining whether the standby signal is asserted;
wherein when the standby signal is asserted, only the standby controller, the linear regulator, and the bandgap generator are in the enabled state.
